(19) United States
(12) Patent Application Publication
(10) Pub. No.: US 2011/0266711 A1
(43) Pub. Date: Nov. 3, 2011

(54) MULTILAYERED FILMS

(76) Inventor: Shilpan Pravinchandra Patel, Mumbai (IN)

(21) Appl. No.: 13/080,386

(22) Filed: Apr. 5, 2011

Related U.S. Application Data
(62) Division of application No. 10/498,283, filed on Jun. 4, 2004, now abandoned.

(30) Foreign Application Priority Data
Dec. 6, 2001 (IN) 1158/MUM/2001

(51) Int. Cl. B29D 7/01; B05D 3/02; B05D 3/00; B05D 5/00

(52) U.S. Cl. 264/212; 427/256; 427/177

(57) ABSTRACT

A pin-hole free multi-layered film having partially or fully water soluble films layered with substantially pin-hole free barrier coatings that are partially insoluble or fully water-soluble or dispersible. The film may include detachable and/or non detachable substrates. The process for manufacturing the film is versatile to accommodate embodiments such as on-line/off-line processing, selective barrier print-coating in flexo-gravure processing individually or in combinations involving especially designed roto-gravure cylinders/flexoplates for multi station registrations and/or multipass operations to achieve substantially pin-hole free films, etc. The barrier coatings may be continuous or discrete and/or selective, based on the end use application.

### CROSS REFERENCE TO RELATED APPLICATIONS

This is a divisional of U.S. application Ser. No. 10/498,283 filed Jun. 4, 2004.

### FIELD OF INVENTION

This invention relates to novel pin-hole free multi-layered films consisting of partially or fully water soluble films layered with substantially pin-hole free barrier coatings that are partially or fully water-soluble or dispersible and methods of manufacturing the same. The invention further relates to substrate based multi-layered films with water soluble or partially water-soluble films layered with substantially pinhole free barrier coatings and method of manufacturing the same.

### BACKGROUND

Cold or hot water soluble films have been used for a variety of packaging applications including wrapping, pouches, bags and containers. Barrier coated soluble films are also known in the packaging industry. A feature that is of significance is clear, easy printing of words, figures, pictures, images etc on such soluble films to provide information on the packaged materials. Barrier coated water-soluble films have wide applications and are well known in the industry. Production of pinhole free barrier coated films of a range of thickness continues to pose challenges. Pinholes in barrier films lead to adverse effects on the packaged products. Plasticiser migration from the water-soluble film into the packed materials is also to be avoided. Pinhole free barrier coating is therefore of vital importance. Normally water-soluble films of this thickness by themselves are very difficult to make and handle due to their tensile strength changing properties. For example physical properties of water-soluble films are very sensitive to small variation in environmental conditions during the process of formation as they are susceptible to the development of brittleness in the presence of hot blast of dehumidified air and may easily tear. Similarly when subjected to high humidity levels such films tend to become highly tensile. Hence the manufacturing process of water-soluble films and its subsequent conversion processes have to be carried out under very rigid process conditions. Production of very thin water-soluble films of film thickness of less than 5 microns is difficult to achieve due to “burn out” effects before reaching the “film-forming stage”. Moreover avoiding the formation of pinholes in conventional processes for water soluble with or without barrier coating has continued to be a problem.

Thus in the field of soluble films a long felt need to develop films with selective barrier protection that would hold a wide variety of materials and at the same time be amenable to easy handling in packaging and printing machines without getting affected during processing or by the product during storage of the products. Water soluble flexible films that are pinhole free, appropriate tensile strength, percentage elongation and impact strength to withstand mechanical stresses during the processing are most suited for a variety of applications including packaging of detergents, pharmaceuticals, agro-chemicals, food products etc. The challenge has been to produce multi-layered barrier films that are substantially pinhole free to withstand stresses during processing and at the same time retain their strength and integrity during storage.

U.S. Pat. No. 5,296,282 describes an invention related to a shaped article characterized by a substrate comprising a degradable, or partially degradable, synthetic polymeric material that degrades via hydrolysis and/or biodegradability; and one or more surfaces of the substrate which are coated with a discontinuous repellant hydrophobic and/or oleophobic material. More specifically the invention in U.S. Pat. No. 5,296,282 relates to shaped articles, particularly in film form, fabricated from synthetic polymeric materials that are degradable by hydrophilic and/or oleophilic liquids, wherein these articles are protected against premature degradation by these liquids. This protection is achieved by incorporating on the surface of the article to be protected a discontinuous surface layer of a hydrophobic and/or oleophobic material that will repel the assaulting or degrading liquids (i.e., hydrophilic and/or oleophilic liquids). The repellant surface is sufficiently discontinuous, normally in the form of a layer of discrete particles, so that degrading gas, vapors and bacteria can penetrate the repellant surface, thereby gaining access to the degradable substrate and initiating degradation of the substrate. However, because of the composition and physical nature (e.g., surface tension), of the repellant surface, the assaulting liquid cannot contact and degrade the substrate. Therefore, the shaped articles of the invention may be used as a container for an assaulting liquid and yet degrade eventually into environmentally benign products.

U.S. Pat. No. 5,300,358 discloses an invention that relates to compostible non-rigid absorbent structures comprising an absorbent degradable fibrous core and a back sheet that is cold water-soluble and contains on both sides of the backsheet a discontinuous layer of aqueous-repellent material. A preferred species can be disposed of by toilet flushing.

U.S. Pat. No. 4,057,537 discloses laminates made from a polyhydroxic acid (PHA), copolymer fibrous matrix, which is consolidated into a rigid, non-porous, laminated structure by flowing molten polymer through the fibrous material and curing it while in a mold or hydraulic press. Synthetic or natural fibers such as cellulose fibers are disclosed as the matrix.

Patent Application WO 90/01521 discloses non-porous rigid laminates made from a fibrous mat consolidated by flowing molten PHA polymer through the fibrous material and curing the polymer in a mold or hydraulic press. Fibers can include cellulose derived from wood.

Published patent application WO 64667 describes an invention with multi-layer soluble film, a method of producing such film, a method of packaging a chemical in such film. The multi-layer film comprises a continuous layer of water-soluble material suitable for forming the outer layer of a bag, and a barrier coating affixed to discrete areas of the continuous layer, leaving a plurality of uncoated intervals occurring at repeating distances on the continuous layer. The barrier coating is accomplished by a roll-coating step that is achieved by a direct flexogravure coating process. The thickness of the barrier coating is in the range between 0.025 microns to 25 microns. The thickness of the water-soluble layer is in the range 12 microns to about 200 microns.

The processes described in the prior art could result in products with pinholes of varying sizes and numbers, as the Water Soluble Film (WSF) is highly susceptible
to outside environmental/climatic factors like heat, humidity, RH, moisture, temperature, cold cracking, and
to plasticiser migration affecting the easy flow of web of WSF during the process of conversion in processes like printing, slitting, over coating or reacting with outside gases and with packaged products.

During the processing of WSF in the printing or print-coating machine the film stretches causing stress and strain in the film. This leads to the formation of pinholes as it picks up the barrier materials in stretched form, not withstanding the best of tension controls put on the machine. After printing or print coating of the barrier materials, the stretched film is wound on a core. During the process of aging in this wound form the WSF tends to return to it's original memory of stress, and has a tendency to “shrink” in the machine direction thereby affecting it's dimensional stability in cross direction. This could result in cracks opening the fragile coatings of barrier with the creation of pinholes. In the processes described therefore require very rigid and expensive environmental control. Such processes have very limited flexibility in that the WSF and its subsequent processing for barrier layering have to be necessarily carried out in the same location.

The processes described in the prior art especially with respect to a single pass barrier coated processes are strongly dependent on the viscosity and solid contents of the barrier material to achieve film thickness needed to manufacture pinhole free barrier coatings. This acts as a limitation for several barrier-coating formulations as a single pass barrier coating system suffers from the disadvantage of not being able to take advantage of using barrier coatings formulations in which the materials are non miscible liquids or liquids having varying pH, viscosity, etc.

### SUMMARY

The main object of the invention is to overcome the weaknesses and unsolved problems of the past and to provide substantially pinhole free multi-layered film products and methods of manufacturing the same. The multi-layered film product consists of a fully or partially water soluble film layered with barrier coating materials that are uniform and substantially free from pinholes, with good gas barrier properties optimal tensile strength, percentage elongation and impact strength to withstand mechanical stresses during the processing and at the same time retain their strength and integrity during storage thereby making them most suited for a variety of applications including packaging of detergents, pharmaceuticals, agro-chemicals, food products etc. The barrier coatings may be continuous of discrete based on the end use application.

Yet another object of the invention is to provide for substrate-based detachable multi-layered films product consisting of a fully or partially water soluble film layered with barrier coating materials that are uniform and substantially free from pinholes, on a wide variety of substrates such as plain or coated paper, plain or embossed fabrics, plain, laminated, embossed or treated polyester films, plain or embossed LDPE/HDPE/HIPS/HMHDPE films or laminations thereof, plain, laminated or Embossed Aluminum foil etc.

Yet another object of the invention is to provide for substrate-based non-detachable multi-layered films with film forming coating materials that are uniform and substantially free from pinholes, on a wide variety of substrates such as plain or coated paper, plain or embossed fabrics, plain, laminated, embossed or treated polyester films, plain or embossed LDPE/HDPE/HIPS/HMHDPE films or laminations thereof, plain, laminated or Embossed Aluminum foil etc.

Yet another object of the invention is to provide a process for using barrier materials such as acrylic acid polymers, acrylic ester polymers, soluble acrylic acid copolymers, soluble acrylic ester copolymers, soluble copolymers of acrylic acids and esters, cross linked polyvinyl alcohols, cross linked cellulose datives, ethyl cellulose, nitrocellulose, cellulose butyrate, cellulose acetate butyrate, ethylene vinyl polyols, ethylene vinyl acetate, PVdC, acrylic emulsion, PVC emulsion, PVDC emulsion, PVB, natural and synthetic waxes, polyurethanes, and modified polyvinyl alcohols, silicone based polymers etc to produce detachable substrate-based multi-layered films. The barrier coatings may be continuous of discrete based on the end use application.

Yet another object of the invention is to produce detached uniform water-soluble substantially pinhole free films with low thickness of about 3 microns to thick films of about 300 microns.

Yet another object of the invention is to produce uniform and substantially pinhole free barrier films with thickness of about 0.25 microns to about 50 microns on water soluble or partially soluble films on diverse substrates that may be detachable. The barrier coatings may be continuous or discrete and/or selective based on the end use application.

Yet another object of the invention is to provide multi-layered film product with hot water soluble films with continuously or discretely layered barrier coating of cold-water soluble film or vice-a-versa based on the needs of the end use application. The barrier coatings may be continuous or discrete and/or selective, based on the end use application.

Another object of the invention is to provide novel method of manufacture of detachable substrate based multi-layered film products using a variety of casting processes and their combinations. The barrier coatings may be continuous or discrete and/or selective based on the end use application.

Yet another object of the invention is to provide for novel methods of selective barrier coating of films to achieve films that are substantially free of pinholes. The barrier coatings may be continuous or discrete and/or selective based on the end use application.

Another object of the invention is to provide multiple options for on-line and off-line processing using a detachable substrate with water-soluble film and selective barrier print-coating in flexo-gravure processing individually or in combination involving especially designed roto-gravure cylinders/flexoplates of varying cell shapes, depths, and thickness.

Another object of the invention is to provide multiple options for on-line and off-line using a detachable substrate with water-soluble film and selective barrier print-coating in flexo-gravure processing individually or in combinations involving especially designed roto-gravure cylinders/flexoplates for multi station registrations and/or multipass operations to achieve substantially pin-hole free films.

Yet another object of the invention is to produce substantially free pin hole free films using combined processes involving flexo, gravure or their combination with multipass and/or multi station registration optionally in combination with full or zone coating in air knife, Mayer Bar including wire rod coating, roll over roll, knife over roll, including full or zone, fountainless gravure including reverse roll coating, five roll/multiple roll coating, pre and post water soluble film formation including full or zone coating released at selective discreet areas. These processes can be pre or post the water-soluble film formation.

Yet another object of the invention is to provide processes for manufacture of substantially pin-hole free barrier coated films pre or post the formation of the water soluble film.

Yet another object of the invention is to produce films using a release coated substrate, which is capable of a pre-coating with a barrier material followed by a final extrusion or casting of water-soluble film.

Yet a further object of the invention is to provide novel interlayer incorporated partially of fully water-soluble or insoluble materials in multi layered films and processes for their incorporation by the disclosed methods.

The present invention discloses novel pin-hole free multi-layered films consisting of partially or fully water soluble films layered with substantially pin-hole free barrier coatings that are partially insoluble of fully water-soluble or dispersible and methods of manufacturing. The invention further relates to substrate based multi-layered films with water soluble or partially water-soluble films layered with substantially pinholes free barrier coatings and methods of manufacturing the same. The barrier coatings may be continuous or discrete and/or selective, based on the end use application.

### BRIEF DESCRIPTION OF THE DRAWINGS

FIG. 1 shows a process for the manufacture of water soluble film

FIG. 2 shows a zone coating device.

FIG. 3 shows a process for the manufacture of substantially pin-hole free multilayer water soluble film.

FIG. 4 shows another process for the manufacture of substantially pin-hole free multilayer water soluble film.

FIG. 5 shows a further process for the manufacture of substantially pin-hole free multilayer water soluble film.

FIG. 6 shows yet another process for the manufacture of substantially pin-hole free multilayer water soluble film.

FIGS. 7A,7B,7C,7D show various gravure cylinders used in the manufacturing processes.

FIGS. 8A and 8B show single cell coatings with pin holes.

FIGS. 8C and 8D show pin hole free cell on cell coatings.

### DETAILED DESCRIPTION

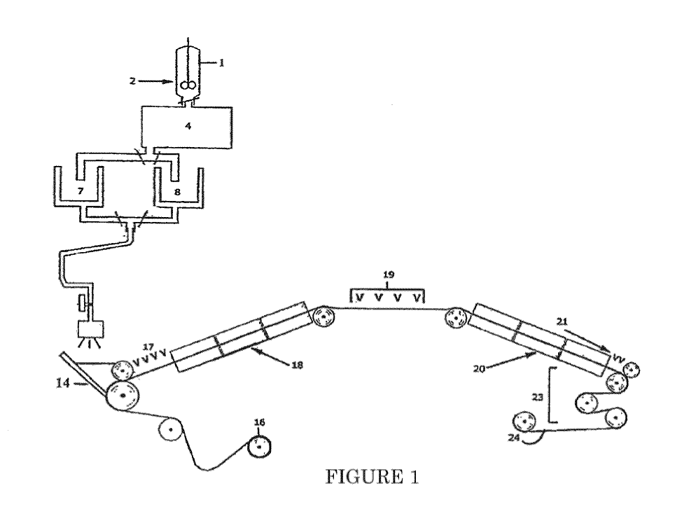

According to the invention the multi-layered films are prepared by a process broadly comprise the steps of:
(i) providing a water soluble film on a detachable substrate, and
(ii) providing a substantially pin hole free barrier coating along the water soluble film or predetermined portion of the water soluble film.
   The water-soluble film is prepared on the detachable substrate as under (FIG. 1):
A batch (2) based on the composition of the water soluble film is charged in the reactor (1) and heated with stirring to ensure good mixing the temperature ranging from about 50° C. to about 250° C., preferably from about 60° C. to about 200° C., more preferably from about 55° C. to about 170° C.
Unloading of the batch in the Master Storage Tank (4) maintained at appropriate temperatures.
Unloading the batch into different storage tanks (7, 8) to enable separate addition of additives under varying conditions and/or to prepare the feed batch to the casting/coating head
Feeding of the batch to the casting/coating head (14) at appropriate temperatures
Casting on a selected substrate or the conveyor belt (16), the temperature being maintained at about 10° C. to about 95° C., preferably between about 13° C. to about 90° C., more preferably between about 15° C. to about 85° C.;
Evaporating the solvents in a controlled manner using heat source (17, 19, 21), drying of the WSF from step (i), the temperature in the dryers (18, 20) ranging from about 50° C. to about 250° C., preferably from about 60° C. to about 200° C., more preferably from about 55° C. to about 170° C.;
Optional chilling of the substrate based film, the temperature range of the chilling cylinder (23) being from about −50 C to about +10 C, preferably about −30 C to about +5 C, more preferably about −4 C to about +2C.
Optional detachment of substrate from film Winding of substrate-based film (24) or separate winding of the detached films.

Further, substantially pinhole free barrier coating on the full web or at discreet places of the substrate based water-soluble film is achieved by any or combination of the following methods:
A) Roto Gravure Cylinders: Using various combinations of depths of cells, shapes of cells and multiple stations and/or multiple passes.
B) Flexo Plates: Using various combinations of depths of cells, shapes of cells and multiple stations and/or multiple passes.
C) Flexo+Gravure Combination:+Multipass and/or multi station registration.
D) Air knife: Full Coating, Zone Coating
E) Mayer Bar—Wire Rod Coating: Full Coating, Zone Coating
F) Roll over Roll: Full or Zone Coating
G) Knife over Roll: Full or Zone
H) Fountainless Gravure: Full or Zone Coating
I) Reverse Roll Coating: Full or Zone Coating
J) Five Roll/Multiple Roll Coating: Full or Zone Coating
K) Pre and Post water-soluble film—Full or Zone Coating Here the barrier material is released selectively at discreet areas.

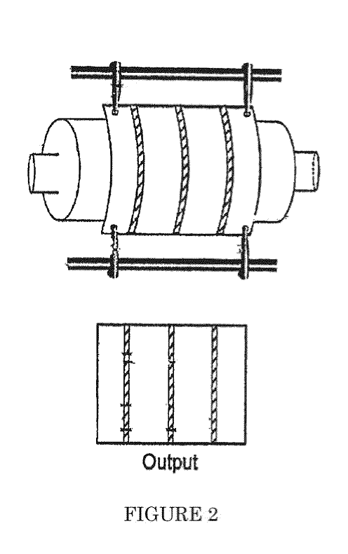

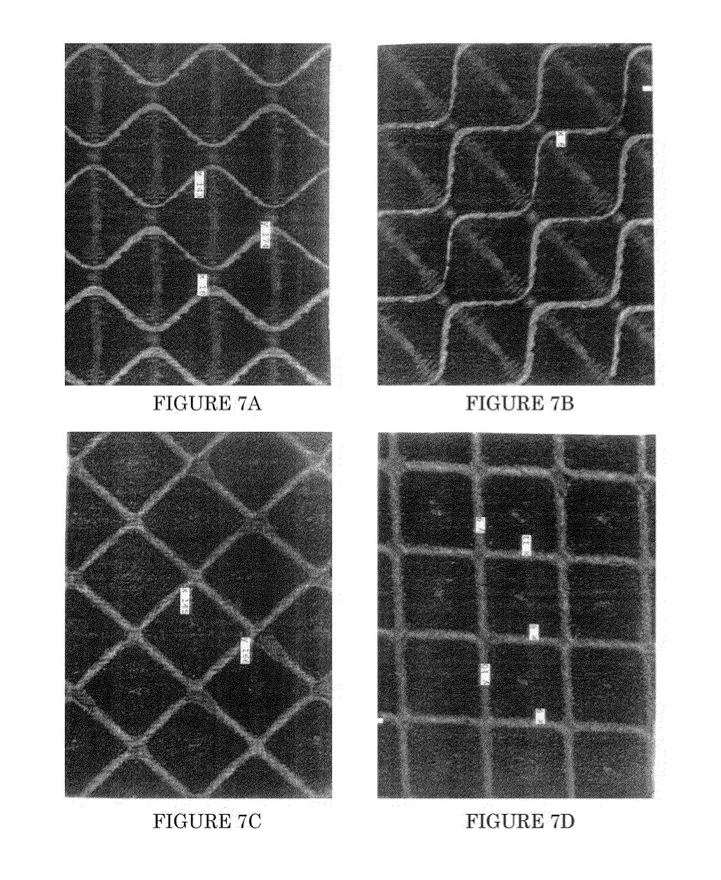

### Gravure Cylinder/Flexoplate Designs (FIGS. 2, 7A, 7B, 7C and 7D)

Gravure cylinders are etched as per the pattern of the discreet barrier coatings to be laid on the substrate based water-soluble film. These etchings are of different screen, shapes and depth. The amount of transfer of the barrier material on to the soluble film is directly proportional to the fineness of the screen on the cylinder. Shapes of the screens on the cylinder can vary with the need. For example they could be triangular, quadrangular, oblique lines, etc. The depth of the screen determines the coat weight of the barrier layer to be transferred. These variables are to be pre-determined based on the barrier material characteristics, such as viscosity, solid content etc., the shape and sizes of the barrier layer zone to be laid on the water-soluble film, thickness of the barrier layer etc. These gravure cylinders and the cells normally have blanks where the lines have not been etched and become responsible for the formation of pinholes in the coated barrier layer.

A non-limiting sample of the diverse shapes, sizes and depths of the gravure cylinders used in this process is given in FIGS. 7A, 7B, 7C and 7D. The parameters such as the cell widths are marked as “X”, and depth of the cell is marked as “Y”. The figure also illustrates the cell wall thickness. It should be clear from the figure that the cylinder is so designed as to have a combination of screens/cells that are of different sizes and shapes, so that as the coated barrier layer sequentially passes over them, the previous pin holes are filled up due to overlap of the designs of the previous screen/cell and the subsequent one. Such an operation in tandem and in registration is responsible in the final formation of a substantially pinhole free barrier layer on the detachable or non-detachable substrate based water-soluble film. Even a reverse printed logo, text or picture can be directly be printed on the water soluble film before or after the barrier layers depending upon the sensitivity of the printing inks to the packaged materials. These multiple layers and reverse printing ensure substantial pinhole free barrier layered product. The gravure process allows the removal of any excess of liquids by the scraping blade and the barrier materials in transferred in a controlled manner to produce the very thin films at every station. The detachable substrate based water soluble film retains proper tension controls and ease in running of the barrier coating which without the substrate would be operationally cumbersome. By using the substrate all environmental factors normally leading to uneven or uncontrollable expansion and contraction of the water-soluble film during the process of barrier layering are avoided as the stresses are borne by the substrate during the process of manufacturing. The present invention also makes it possible to conduct multiple pass, multi-design, multi depth cylinders to ensure substantially pinhole free barrier layers.

The flexoplate designs that may be used for the production of substantially pinhole free barrier coatings are similar to those described for the designing of the gravure cylinders.

### Drying of the Film:

In one of the embodiments involving the drying steps, a set of drying chambers maintained at different temperatures are used for controlled drying of the water-soluble film, the temperature in the dryers ranging from about 50° C. to about 250° C., preferably from about 60° C. to about 200° C., more preferably from about 55° C. to about 170° C.; These chambers allow for the controlled removal of the solvent, facilitate the process of controlled semi-gel formation, complete curing, removal the evaporated solvent including the vaporized impurities from within the film.

Various embodiments of the process to produce substantially pinhole free barrier coatings on detachable substrate based soluble films are described below.

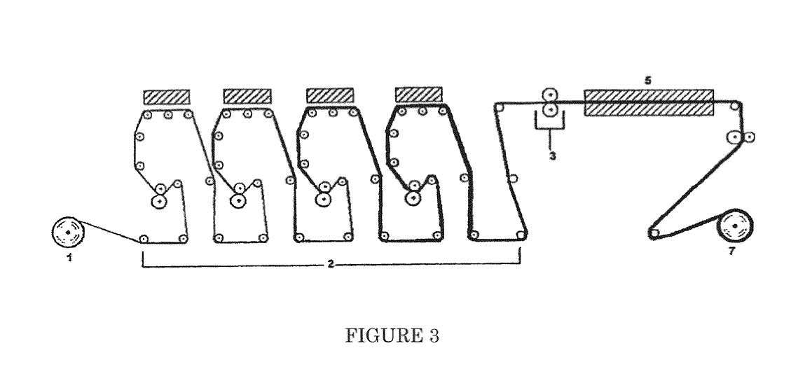

In one of the embodiments, release coated substrate is used to pre-coat barrier materials either singly employing flexo or gravure print coat process or in combination with other casting or coating methods to get a final product (FIG. 3) using the following steps.
Unwinding of the Substrate (1)
Passing the release coated substrate through various stations (2) of Gravure—Flexo—or coating stations singly or in combinations
Drying and curing after each station. The temperature range after each station range from about 50° C. to about 200° C., preferably from about 60° C. to about 160° C., more preferably from about 55° C. to about 150° C.;
Passing through the WSF casting station (3)
Drying and curing. The temperature in the dryers (5) vary from about 50° C. to about 250° C., preferably from about 60° C. to about 200° C., more preferably from about 55° C. to about 170° C.
Optionally chilling the film
Winding or detaching the substrate (7) and winding.

In an embodiment of this process, a non-detachable substrate may be unwound, followed by a barrier coating at a gravure coating station, and subsequently smoothened by controlled flow of air from an airknife and subjected to drying at appropriate temperatures. Optionally such an operation may be done at a plurality of the gravure stations having airknifes at every stations or at the last station thereby ensuring the minimization of pinholes.

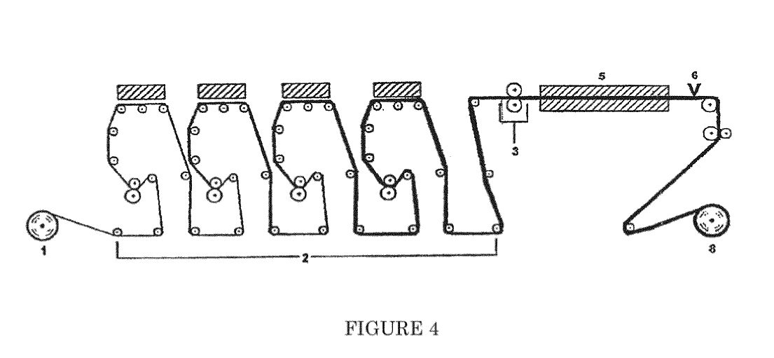

In another embodiment, the process may combine a release-coated substrate on which barrier materials are layered singly or in combination followed by solution casting of WSF and then extrusion casting of WSF (FIG. 4) as follows using.
Unwinding the substrate (1)
Passing the release coated substrate through various stations (2) of Gravure—Flexo—or coating stations singly or in combinations
Drying and curing of the film after each station. The temperature after each station range from about 50° C. to about 200° C., preferably from about 60° C. to about 160° C., more preferably from about 55° C. to about 150° C.;
Passing of the film through the casting station (3)
Drying and curing of the film. The temperature in the dryers (5) range from about 50° C. to about 250° C., preferably from about 60° C. to about 200° C., more preferably from about 55° C. to about 170° C.
Extrusion of water-soluble film on the precast water-soluble film. The temperature at extrusion casting head (6) ranges from about 350° C. to about 100° C., preferably from about 300° C. to about 250° C., more preferably from about 240° C. to about 150° C.
Chilling the product
Winding or detaching the substrate (8) and winding.

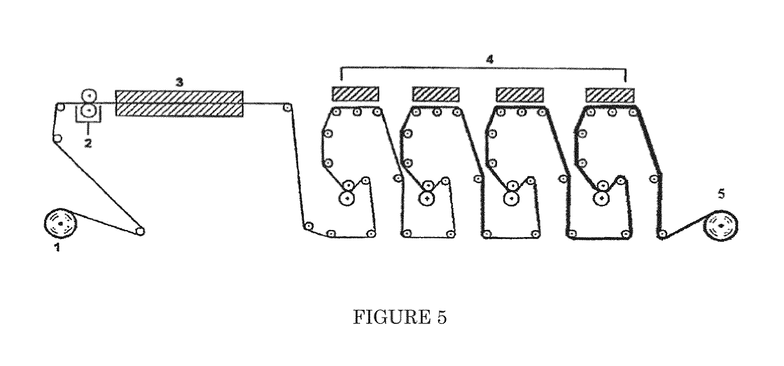

In yet another embodiment of the process, a post barrier print coat on solution cast WSF may be performed as follows (FIG. 5):
Unwinding of the substrate (1)
Casting (2) of the water soluble film,
Drying and curing of the film. The temperature in the dryers (3) ranging from about 50° C. to about 250° C., preferably from about 60° C. to about 200° C., more preferably from about 55° C. to about 170° C.
Passing through various stations (4) of Gravure—Flexo—or coating stations singly or in combinations
Drying and curing after each station The temperature after each station range from about 50° C. to about 200° C., preferably from about 60° C. to about 160° C., more preferably from about 55° C. to about 150° C.;
Optionally chilling the film
Winding or detaching the substrate (5) and winding.

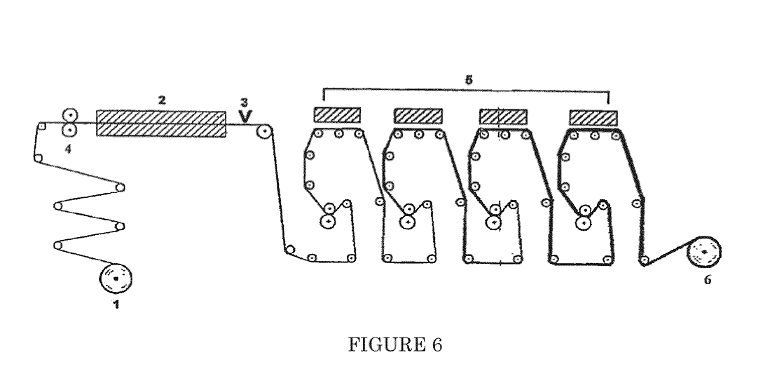

In another embodiment, the process may combine Solution Cast with Extrusion cast and laying of barrier layers (FIG. 6) as follows:
Unwinding of the substrate (1)
Casting (4) of the water-soluble film
Drying and curing of the film. The temperature in the dryers (2) ranging from about 50° C. to about 250° C., preferably from about 60° C. to about 200° C., more preferably from about 55° C. to about 170° C.
Extrusion (3) of water-soluble film on the precast water-soluble film
Pass of the film through various stations (5) of Gravure—Flexo—or coating stations singly or in combinations
Drying and curing after each station. The temperature after each station range from about 50° C. to about 200° C., preferably from about 60° C. to about 160° C., more preferably from about 55° C. to about 150° C.;
Optionally chilling the film
Winding or detaching the substrate (6) and winding.

In one of the embodiments of the invention the multi-layered film product consists of the substrate, the water soluble or partially soluble film with the substantially pinhole free layered barrier coating with the option of detaching the substrate during the off-line applications such as pouch making, printing etc.

In another embodiment of the invention the detachment of the substrate may be done on-line at the end step of the production of the substrate based multi-layered film product.

In another embodiment of the invention the substrate based multi-layered product may be used with the substrate as such and the detachment of the substrate takes place during use of the final packed product.

In another embodiment of the invention pinholes can be controlled, using the same process disclosed in this invention with tailored misregistration of the gravure cylinders. However the results would not be as good as the system using sequential gravure cylinder of diverse cell designs.

### Example

Gravure Cylinders having various shapes, with depths of 55, 62 and 77 microns, screen angles-lpi of 70-38, 60-38 and 48-38 respectively using stylus of 120, 125 and 135 and cell channel walls of 26, 32 and 37 were prepared. Water soluble film was cast by using solution casting method. Casting of solution was done on clear polyester film. The thickness of the WSF was controlled by metering the thickness by roll over roll coating head. The WSF was sent through dryers, the temperature in the dryers ranging from about 50° C. to about 250° C., preferably from about 60° C. to about 200° C., more preferably from about 55° C. to about 170° C.; The polyester film and the freshly formed water-soluble film were rewound on a paper core. This web was then taken to a multiple station gravure-printing machine, with an airknife mounted on every station. Dye was mixed with the barrier materials placed in the gravure tray to enable monitoring of the pinholes in the formed layered barrier film under a transmission microscope. The cylinders used had a strip design with the parameters mentioned above. The barrier coating was affected with the passing of the web over the cylinders and the airknife smoothened the coating. Experiments were performed to get single pass, double pass and triple pass. These were repeated with cylinders of different cell designs.

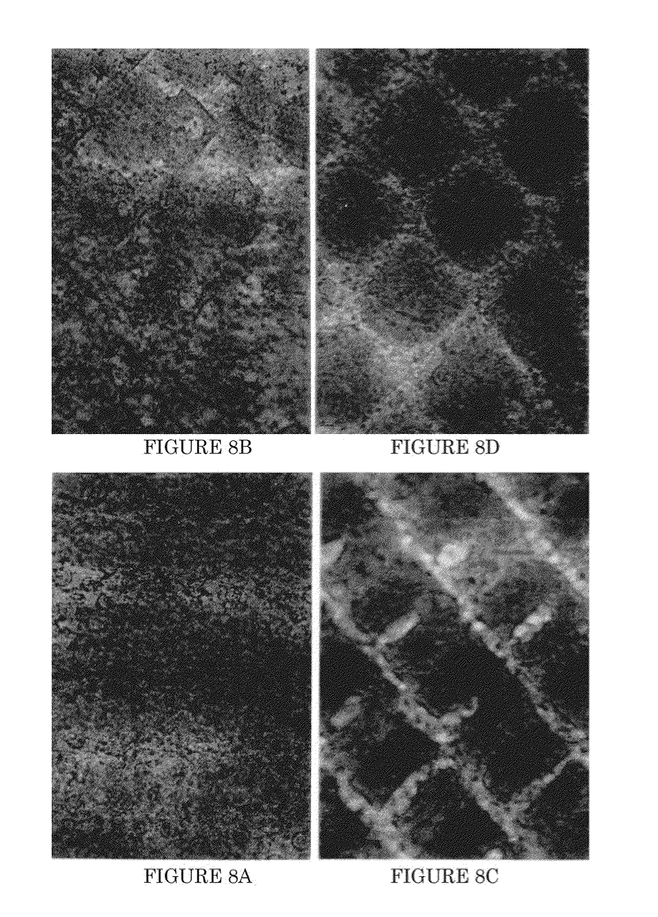

The samples prepared were examined under a transmission microscope for the pinholes. FIGS. 8A, 8B and 8C present a few photographs of such an examination. The gap between the cells in white, as shown in picture in the photographs represents the pinholes. It may be observed that the photographs of FIGS. 8A and 8B which corresponds to single cell coating shows several pinholes. The photograph of FIG. 8C represents cell on cell coating which leads to substantial reduction in the pinholes as the two cell wells in the subsequent passes do not overlap with each other.

In another set of experiments, coating was affected by gravure cell on cell on cell of different parameters and the passing through a smooth flow of precisely controlled air from between the two lips of the airknife to precisely control the solution flows. This enhances the pinhole free nature of the barrier-coated films as shown in the photograph of FIG. 8D especially in the case of airknife where the barrier material “filled in” the pinholes, by flowing out the solution so as to cover the cell walls which are responsible for the pinholes.

As water soluble films are sensitive to ambient environment such as heat, cold and relative humidity, the substrate film, for example polyester film, used for casting, ensures that it controls the tension and other film properties during the subsequent process of conversion, particularly when done offline. During offline transportation the substrate also acts as a protective cover to the water-soluble film against environmental variations during transportation to other locations of converters for the barrier coating operations.

The advantages of the present invention is that it provides for optionally detachable substrate based water soluble films continuously or discretely layered with substantially pinhole free barrier coating of controlled thickness, possessing excellent dimensional stability and uniform thickness across the entire length of the film. It also provides means for producing the same using combined processes involving flexo-gravure combination with multi-pass and/or multi station registration optionally in combination with air knife full coating, zone coating, Mayer Bar including Wire Rod coating, full coating, zone coating, roll over roll including full or zone coating, knife over roll including full or zone, fountainless gravure including reverse roll coating, five roll/multiple roll coating, pre and post water soluble film formation including full or zone coating released at selective discreet areas. This provides options for on-line or off-line processing of the substrate based multi-layered film depending on the end use application.

The further advantage of the present invention is that it offers options to prepare the detachable substrate based water soluble film in one location and safely transport it to another location for the barrier coating thereby making it possible multi source the operation based on the need and availability of facilities. Moreover depending on the end use of the product the water-soluble film of the features of the water-soluble films properties (e.g. tack values during the process of formation of the film) the substrate material can be selected to provide special effects or properties. For example if online embossing is desired then an embossed substrate of the particular design maybe chosen. The substrate may be used in several forms such as roll or sheet selected from paper, any heat resistant film fabric, aluminum foil, with or without release (silicon or any other release coated) coatings etc.

Another advantage is wide flexibility of the process to tailor conditions as per the end use of the formulation of the developed properties during the film forming process. For example the substrate may be brought into the process at various stages of the process. For example the substrate that is chosen as per the formulation of the water soluble film at stage I (where the film is not yet formed, but is just casted and is very wet) or at stage II where the film may start becoming tacky or non tacky (release within itself) or at stage III where the film is substantially formed. External chilling or superfluous offline heating and other treatments are possible, particularly where the film is not fully formed and is let to age internally with infra red heating is needed to give it desired properties. Such flexibility is not possible with a pre-casted water-soluble film, manufactured on a metal belt or by bubble extrusion methods.

In the present invention even non-coated substrates can be used unlike in process involving pressure sensitive adhesives that are permanently tacky and thus cannot function without a silicon or other release coating.

Barrier coated films produced by the process disclosed in this invention have very good machinability, cold crack resistance toughness on all kinds of converting machine, mechanical properties compared to others particularly in tensile strength in both machine and transverse direction. Seal strength is also good in the vertical direction. The heat seal temperature is around 50 deg. C. to 200 deg. C. depending on the moisture content within the film and the ambient humidity and whether the heat sealing is done with or without the substrate.

The substantially free pinhole free barrier coated films disclosed in this invention are most suited for a variety of applications including packaging of detergents, pharmaceuticals, agro-chemicals, food products, laundry, etc. involving wrapping, pouches, bags, containers, etc. These also find applications in embroidery and allied areas.

1. A process for the preparation of barrier coated water soluble films comprising a water soluble film and a barrier coating on one side of said water soluble film, said process including the steps of providing a plurality of coating heads having a coating surface with cells of pre-determined depth and shape, and applying said barrier coating by means of said plurality of coating heads whereby said barrier coating comprises a plurality of layers of barrier material and pin holes in one layer of said barrier coating are offset relative to pin holes in another layer of said barrier coating such that said layers of barrier material provide a substantially pin hole free barrier coating.

2. A process according to claim 1 wherein said plurality of coating heads comprise one or more gravure cylinders or flexo-plates or combinations thereof.

3. A process according to claim 1 wherein said plurality of coating heads are configured with discrete combinations of cells that are of different sizes and shapes and said barrier coating is formed by sequentially passing said discrete combinations such that pin holes are filled up due to overlap of voids of a previous combination of cells and voids of a subsequent combination of cells to produce a pinhole free barrier layer.

4. A process according to claim 1 wherein said barrier coated water soluble film is formed upon a substrate that is subsequently detached.

5. A process according to claim 4 wherein said substrate and said barrier coating are on opposite sides of said water soluble film.

6. A process according to claim 4 wherein said substrate comprises a polyester film.

7. A process according to claim 1 wherein said water soluble film is formed by the steps of:—
i. preparing a batch solution based on a composition of said water soluble film
ii. feeding the batch solution to a casting/coating head
iii. casting said water soluble film upon a substrate
iv. pre-curing said water soluble film using a heat source
v. winding said water soluble film on a winder.

8. A process for the preparation of a barrier coated water soluble film comprising a water soluble film and a barrier coating on one side of said water soluble film wherein said barrier coating is applied in a plurality of directly adjacent layers by a plurality of coating stations having cells configured such that pin holes in each layer do not overlap with each other whereby a pin hole free layered barrier coating is produced.

9. A process according to claim 8 wherein said plurality of coating stations employ gravure cylinders or flexo plates or combinations thereof having a combination of depth of cells and shapes of cells.

10. A process according to claim 9 wherein combinations of cells that are of different sizes and shapes are provided and said barrier coating is formed by sequentially passing the combinations such that previous pin holes are filled up.

11. A process according to claim 8 wherein said barrier coated water soluble film is formed upon a substrate that is subsequently detached.

12. A process according to claim 11 wherein said substrate and said barrier coating are on opposite sides of said water soluble film.

13. A process according to claim 8 wherein partially or fully water-soluble or insoluble materials are incorporated in said barrier coated water soluble film.

14. A process according to claim 8 wherein said barrier coating is applied continuously using full coating or discretely using zone coating.

15. A process according to claim 8 wherein said water soluble film comprises one or more layers of water soluble material.

16. A process according to claim 15 wherein said water soluble film is formed by casting, extrusion or a combination of casting and extrusion of said one or more layers.

17. A process according to claim 8 further comprising the following steps:
a. unwinding a release coated substrate
b applying said barrier coating to the substrate by passing said release coated substrate through said plurality of coating stations
c. drying and curing said barrier coated substrate,
d. casting a water soluble film layer upon said barrier coating by passing said barrier coated substrate through a casting station
e. drying and curing of said cast film layer,
f. extruding a water soluble film layer upon said cast water soluble film layer, and
g. chilling said barrier coated water soluble film.

18. A process according to claim 8 further comprising the following steps:
a. unwinding a substrate
b. casting a water soluble film layer upon said substrate
c. drying and curing of said cast film layer
d. extruding a water soluble film layer upon said cast water soluble film layer
e. applying said barrier coating to said multi layer water soluble film by passing said water soluble film coated substrate through said plurality of coating stations;
f. drying and curing said barrier coated water soluble film
g. chilling said barrier coated water soluble film

19. A process according to claim 8 further comprising providing a substrate, and forming said barrier coated water soluble film upon said substrate, wherein said substrate provides tension control during formation of said barrier coated water soluble film.

20. A process for the preparation of a barrier coated water soluble film comprising a water soluble film and a barrier coating on one side of said water soluble film wherein said barrier coated water soluble film is formed upon a substrate and said barrier coating is applied in a plurality of directly adjacent layers by a plurality of coating stations having cells of pre-determined size and shape, and wherein said substrate provides tension control and bears stresses during formation of said barrier coated water soluble film such that said barrier coated water soluble film has a substantially pin-hole free barrier coating.

21. A process according to claim 20 wherein said substrate comprises a polyester film.

22. A process according to claim 20 wherein said barrier coated water soluble film is capable of being heat sealed with or without said substrate.
